(19) United States
(12) Patent Application Publication
(10) Pub. No.: US 2022/0044586 A1
(43) Pub. Date: Feb. 10, 2022

(54) POPULATION-SAMPLE REGRESSION IN THE ESTIMATION OF POPULATION PROPORTIONS

(71) Applicant: Ronald Weitzman, Carmel, CA (US)

(72) Inventor: Ronald Weitzman, Carmel, CA (US)

(21) Appl. No.: 17/505,529

(22) Filed: Oct. 19, 2021

Related U.S. Application Data
(63) Continuation-in-part of application No. 16/267,276, filed on Feb. 4, 2019, now Pat. No. 11,151,895.
Application No. 16/267,276 is a continuation-in-part of application No. 13/923,217, filed on Jun. 20, 2013, now Pat. No. 10,198,961.
Application No. 13/923,217 is a continuation of application No. 11/845,677, filed on Aug. 27, 2007, now Pat. No. 10,957,217.
(60) Provisional application No. 60/823,625, filed on Aug. 25, 2006.

(51) Int. Cl. G09B 19/00; G06Q 10/04

(52) U.S. Cl. CPC G09B 19/00; G06Q 10/04

(57) ABSTRACT

Accordingly, embodiments of the present invention advantageously account for item discrimination in a single-parameter logistic model used for measuring a test-taker's ability and an item's difficulty. Accounting for item discrimination improves the reliability of a test without increasing the number of test items. To account for item discrimination in a single-parameter logistic model, this invention uses the correlation between item response (correct or incorrect) and total test score or other measure of test-taker ability to obtain a Bayesian estimate of the correct-response probability (between zero and one). This correlation is a measure of item discrimination. The numerator in the formula for this correlation contains the difference between the average test score of test-takers who got the item right and the average test score of test-takers who got the item wrong.

### CROSS-REFERENCE TO RELATED APPLICATIONS

is application is a Continuation-in-Part of and claims benefit to co-pending, commonly owned U.S. Patent application Ser. No. 16/267,276, now U.S. Pat. No. 11,151,895, filed Feb. 4, 2019, entitled “Population-Sample Regression in the Estimation of Population Proportions,” to Weitzman, which in turn was a Continuation-in-Part of and claimed benefit to co-pending, commonly owned U.S. patent application Ser. No. 13/923,217, filed Jun. 20, 2013, which was a continuation of U.S. patent application Ser. No. 11/845,677 filed Aug. 27, 2007 which claimed the benefit of U.S. Provisional Patent Application No. 60/823,625 filed Aug. 25, 2006, and was a continuation of U.S. patent application Ser. No. 12/972,397 filed Dec. 17, 2010, which claimed the benefit of U.S. Provisional Patent Application No. 61/288,156 filed Dec. 18, 2009, all of which are incorporated herein by reference in their entireties.

### BACKGROUND OF THE INVENTION

There are numerous methods of estimating population proportions for polls. In 1961, James and Stein derived estimators of population means that are more efficient than corresponding traditional estimators by using a linear combination of the mean of an individual sample and the overall mean of the sample aggregated with two or more other samples from possibly different populations. Being within the 0-1 interval, the weight applied to each individual sample mean is called a shrinkage coefficient.

Commenting on the empirical Bayesi an treatment of James-Stein estimators by Efron and Morris (1973), Stigler (1983, 1990) showed that the shrinkage coefficient was an estimator of the squared correlation coefficient in the regression of population on sample means. Fienberg and Holland (1973) extended the empirical Bayesian treatment of James-Stein estimators to single-sample population proportions, with the expected increase in efficiency.

Likewise, there are numerous methods of testing the ability of a subject and/or the difficulty of a task. Testing methods originally tended to focus on the total test score. Over time testing methods have developed to include a focus on individual responses.

As the focus on total test scores in classical test theory shifted to individual item responses in modern test theory, the models underlying the theories changed correspondingly from measurement and estimation to probabilistic models. In the measurement model of classical test theory, an observed test score (X) differs from a true test score (T) by error (E): X=T+E. Measurement error (E) formally disappears in modern test theory, where the concept of uncertainty expressed by response probability replaces the concept of imprecision expressed by measurement error. In modern test theory, the probability of a correct response to an item is a function of an examinee's ability (θ) and the item's difficulty (b), as well as possibly other item parameters such as the discrimination parameter (a) and, for multiple-choice items, the guessing-rate parameter (c): P(θ, a, b, c). While probabilistic models involving all three item parameters are popular because of their promise of optimal fit, many test developers use the statistically simpler single-parameter logistic model introduced by Rasch (1960):

$$P ( θ ; b ) = \frac{1}{1 + {e}^{- ( θ - b )}} \qquad ( 1 )$$

the graph of which is an ogive curve centered at b on the θ scale.

Prior to Rasch (1960), Birnbaum (1958) introduced logistic item response models, his two-parameter version involving both the location (difficulty) parameter b and the slope (discrimination) parameter α:

$$P ( θ ; α , b ) = \frac{1}{1 + {e}^{- α ( θ - b )}} \qquad ( 2 )$$

Like Equation (1), the graph of Equation (2) is an ogive on the θ scale centered at b; but, different from Equation (1), the slope of the ogive may vary depending on the value of the parameter a, which, in the context of the relationship between measurement error and response probability, is the focus of this disclosure.

Some test developers may consider the single-parameter model described by Equation (1) as unnecessarily limited in its data-fitting ability in contrast to alternatively available two- or three-parameter models. Yet, studies show that the Rasch model may fit data at least as well as its multiple-parameter counterparts (e.g., Forsyth, Saisangjan, & Gilmer, 1981). Thissen (1982), in particular, showed that the addition of the parameter a to the Rasch model may fail to improve model fit significantly. Because other studies may show otherwise (e.g., DeMars, 2001, and Stone & Yumoto, 2004), some test developers who favor the Rasch model might still wish that a single-parameter logistic model could accommodate differences in item discrimination, as well as item difficulty. At the same time, the allowance of differences in item discrimination to affect the estimation of θ values may disturb other supporters of the Rasch model because they believe it unfair to weight responses to items differently, at least without informing test-takers. That concern, however, cannot justify counting clearly less and more discriminating items equally in scoring, particularly when the results of equal and appropriate unequal weighting of item responses differ substantially.

Different from the development here, involving estimation of item discrimination from data, Verhelst and Glas (1995) introduced the discrimination parameter a, into the Rasch model as an unestimated constant to account for varying item discrimination. Because it explicitly lacked the unweighted-scores property of the Rasch model, they also referred to their model simply as a single-parameter logistic model. Weitzman (1996) used an adjustment of x_{iq} like p_{iq} (see below, Detailed Description of Invention) to enable the Rasch model to account for guessing, but that adjustment required the assumption that the guessing rate was constant over items. Weitzman (2009) provides the original account of the invention described here.

Generally, single-parameter models do not tend to account for item discrimination, which is how well the item measures what it is supposed to measure. Single-parameter models do, however, lead to accurate equating of different test forms. Two and three parameters models tend to account for item discrimination. However, two and three parameter models lead to inaccurate equating of different test forms. Accordingly, a need exists for improved test modeling.

### SUMMARY OF THE INVENTION

The present technology may best be understood by referring to the following description and accompanying drawings that are used to illustrate embodiments of the present technology directed toward application of regression of a true measurement on an observed measurement to statistical estimation of the true measurement.

In a population proportion on sample proportion regression embodiment of the present technology, a method for determining the results of a poll having a smaller than conventional margin of error for any sample size or a smaller than conventional sample size for any margin of error, the method comprising statistically determining the regression of population on sample proportions by using an unbiased estimator of the square of the correlation between them. Applying this method to a single sample obtained randomly with replacement from a single population results in credibility intervals that are narrower than conventional confidence intervals, shown to be a product of the regression of sample on population proportions. Not only does the squared-correlation estimator function as a shrinkage coefficient in a Bayesian context, but also this correspondence is shown to apply generally to the estimation of population means as well as proportions. In a preferred embodiment, population-sample regression is used to develop corresponding frequentist and Bayesian estimators.

In another embodiment, a method is presented for estimating population from sample proportions that produces margins of error narrower for any specific sample size or that requires a sample size smaller for any specific margin of error than do previously existing methods applied to the same data. This method applies an unbiased estimator of the squared correlation between population and sample proportions to determine point and interval estimates of population proportions in a regression context involving simple random sampling with replacement. In virtually all reasonable applications, assuming a Dirichlet prior distribution, the margin of error produced by this method for a population proportion is shown to be 1.96 times the posterior standard deviation of the proportion.

In regressing a probability of a correct answer on an actual response in an embodiment of the present technology, a delta single-parameter logistic modeling technique is described. The delta single-parameter logistic model includes receiving a response for each item and each test-taker, and a total test score for each test-taker. A correlation between the item response and the total test score over the plurality of test-takers is determined. Using this correlation, which measures item discrimination, a Bayesian estimate of the probability of a correct response by each test-taker to each item is determined. The logit of this probability estimate is computed. The difficulty of each item is estimated as a function of the average logit over the number of test-takers. Each test-taker's ability is also estimated as a function of the average logit and the average difficulty over the number of test items.

In another embodiment, substituting the latest estimated test-taker ability for the total test score, the delta single-parameter logistic modeling technique is iteratively performed to improve the estimate of the test-taker's ability. In yet another embodiment of the present technology, the delta single-parameter logistic modeling technique is combined with a Rasch modeling technique to improve the estimate of the test-taker's ability and the difficulty of the task.

Accordingly, embodiments of the present invention advantageously account for item discrimination in a single-parameter logistic model used for measuring a test-taker's ability and an item's difficulty. Accounting for item discrimination improves the reliability of a test without increasing the number of test items. To account for item discrimination in a single-parameter logistic model, this invention uses the correlation between item response (correct or incorrect) and total test score or other measure of test-taker ability to obtain a Bayesian estimate of the correct-response probability (between zero and one). This correlation is a measure of item discrimination. The numerator in the formula for this correlation contains the difference between the average test score of test-takers who got the item right and the average test score of test-takers who got the item wrong.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 illustrates the regression of the sample proportion P on the population proportion 71

FIG. 2 illustrates the regression of the population proportion π on the sample proportion P.

FIG. 3 illustrates Bayesian (π-on-P) as a percentage of frequentitst error margins in a two-option case.

FIG. 4 illustrates Bayesian (π-on-P) error margins in the two-option case.

FIG. 5 shows a flow diagram of a π-on-P point and interval estimation.

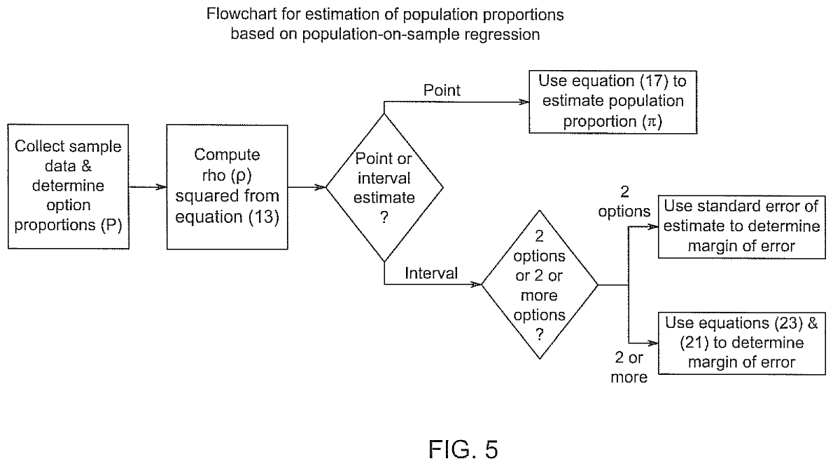

FIG. 6 shows credibility-interval coverage of ±1.96 standard errors in most applications of π-on-P estimation.

FIG. 7 shows a comparison of π-on-P with other estimates in a particular example involving three options.

FIG. 8 shows a comparison of critical with Bayesian and conventional margins of error.

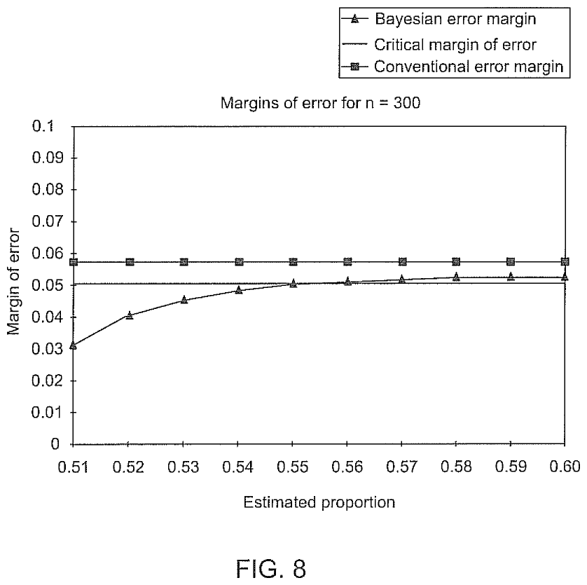

FIG. 9 shows a comparison of samples sizes required to produce commonly used error margins.

FIGS. 10A and 10B show a flow diagram of delta single-parameter logistic modeling methods, in accordance with a number of embodiments of the present technology.

FIG. 11 shows a table comparing item difficulties and item discrimination data for various modeling techniques.

FIG. 12 shows a graph comparing Rasch and delta single-parameter logistic model validities.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

Embodiments of the present technology are directed toward simple regression of a “true” measurement on an “observed” measurement. The direction of this regression (“true” on “observed”) corresponds to Bayesian analysis, whereas the opposite direction corresponds to classical (or standard) estimation in statistics. In one embodiment, the true measurement may be a population proportion, and the observed measurement may be a corresponding sample proportion. In another embodiment, the true measurement may be the probability of a correct response to an item by a particular person, and the observed measurement may be the actual response by that person to the item. The simple regression involves a correlation between the variables on the two sides of the equation.

In population proportion-on-sample proportion regression embodiments of the present technology, an estimator of population proportions is developed that is even more efficient than the Fienherg-Holland estimator, particularly in a small sample (n<500), and demonstrates that all shrinkage coefficients are estimators of squared correlation coefficients in population-on-sample regression. The margins of error for the population proportions, provided they follow a Dirichlet distribution, are shown to be 1.96 times their standard deviations in virtually all realistic applications. These techniques relate to the technical field of poll-taking, particularly utilizing statistics which encompass the estimation of population proportions from the regression of population on sample proportions. Using an unbiased estimator of the square of the correlation between the population and sample proportions in a Bayesian context produces not only point estimates of the population proportions but also credibility intervals that are narrower than corresponding conventional confidence intervals.

Simple regression analysis in statistics is a procedure for estimating the linear relationship between a dependent variable and an independent variable in a given population. The relationship for standardized variables is expressed as an equation for a straight line in which the coefficient of the independent, or regressed-on, variable in the equation is determined from a sample. While the dependent variable may vary, the regressed-on variable is fixed. This variable is the sample statistic, mean or proportion, in population-on-sample regression. This is why population-on-sample regression corresponds to Bayesian estimation. The opposite is true of sample-on-population regression, which corresponds to frequentist estimation in which the population parameter, mean or proportion, is fixed.

A point-estimation advantage of the population-on-sample regression procedure is that it generally avoids the problem of relative-frequency estimates equal to zero or one by reasonably adjusting them away from these extreme values. This inward adjustment is the result of regression toward the mean, which for relative frequencies is greater than zero and less than one.

Population-on-sample regression shares the efficiency advantage of Bayesian over traditional estimation, which shows itself in a reduction of least-squares risk functions with a corresponding shortening of confidence intervals. In mental test theory, for example, standard errors of estimate, used to determine confidence intervals for true scores, are shorter than standard errors of measurement, used to determine confidence intervals for observed scores. The “shrinkage coefficient” in this case is the squared true-observed-score correlation, and the standard error of estimate is equal to the standard error of measurement time this correlation.

The method comprising embodiments of this invention provides for both point and interval estimation for arriving at usable results of a poll. The approach to each follows both frequentist and Bayesian tracks within a regression framework. Development of either the frequentist or the Bayesian point estimator makes no distributional assumption about the population proportions. Distributional assumptions come into play only in the treatment of interval estimation. Normally a regression approach will require three or more observations to accommodate the need to estimate the slope and the intercept of the regression line from data. However, because the mean requires no estimation in the case of single-sample proportions, being the reciprocal of the number of options or categories, the Bayesian as well as the frequentist point estimator developed herein can apply to data involving only two (binomial or multinomial) observations.

The focus here physically has been on a single sample obtained from a single population. Conceptually, the sample may be one of many that the population can produce or the population may be one of many that can produce the sample. The first possibility underlies the frequentist approach and the second the Bayesian approach to statistical inference. The method constituting embodiments of this invention has adopted the Bayesian approach showing that it can lead through regression to considerably more efficient estimation of population proportions than the frequentist approach, especially for samples no larger than 500.

Although reference is made explicitly to proportions, the method applies equally to other forms of expressing such results of a poll, for example, percentage, fractions, and decimal fractions, with appropriate adjustments known by those skilled in the art.

The following steps develop the regression point and interval estimators in the frequentist (P-on-π) case (Step 1) and in the Bayesian (π-on-P) case (remaining steps).

### The Regression of P on π

The frequentist approach to point estimation via regression corresponds to the traditional estimation procedure in which, for a sample of size n, nP (an integer) has a binomial of a multinomial distribution with Eₜ(Pₖₜ)=πₖfor each option k of a total of K options, t indexing the sample. The regression expressing this or the Bayesian approach involves, for a single sample t, the mean P̅and μ_{π} over options

$$( {μ}_{π} = \overline{P} = ( \frac{1}{K} ) {\sum }_{k = 1}^{K} {P}_{k t} ) ,$$

the standard deviations S_{P} and σ_{π} over options

$$( {S}_{P} = \sqrt{\frac{1}{K} {\sum }_{k = 1}^{K} {( {P}_{kt} - {μ}_{P} )}^{2}} ) ,$$

and the correlation coefficient ρ_{πP} over options. To assure that Eₜ(Pₖₜ)=πₖ, the slope coefficient in the regression

$${P}_{kt} = ( \frac{{S}_{P}}{{σ}_{π}} ) {ρ}_{π P} {π}_{k} - ( \frac{{S}_{P}}{{σ}_{π}} ) {ρ}_{π P} {μ}_{π} + \overline{P} + {ϵ}_{kt} \qquad ( 3 )$$

must be equal to one, the population and sample means μ_{π} and P̅ being equal to 1/K, so that Pₖₜ=πₖ+∈ₖₜ, where ∈ₖₜ denotes sampling error. Since Eₜ(∈ₖₜ)=0, Eₜ(Pₖₜ)=πₖ, as in the traditional binomial or multinomial estimation procedure. The regression implication of Eₜ(Pₖₜ)=πₖ then is that the correlation ρ_{πP} between πₖ and Pₖₜ must be equal to the ratio of their standard deviations, σ_{π} and σ_{P}:

$${ρ}_{π P} = \frac{{σ}_{π}}{{S}_{P}} \qquad ( 4 )$$

This result resembles a basic result of classical mental test theory (Gulliksen, 1950) in which π represents a true and P an observed score. The next section will use this result to obtain an estimator of ρ_{πP}².

Step Two—An Estimator of ρ_{πp}²

In this as in the previous section, for each option k, πₖas the regressed-on variable is assumed to be fixed while Pₖₜ can vary over samples (t=1, 2, . . . ). Ordinarily the exact value of ρ_{πP}² is unknown. Because Pₖₜ is a proportion, however, σ_{π}² is expressed in terms of σ_{P}², the expected value of S_{P}², for substitution into Equation (4) to yield an estimator of σ_{πP}² in which σ_{P}² is replaced by S_{P}² :

$${S}_{P}^{2} = \frac{1}{K} {\sum }_{k = 1}^{K} {( {P}_{kt} - {μ}_{P} )}^{2} \qquad ( 5 )$$

where μ_{P} is the mean of the K values of Pₖₜin sample t. Without further assumptions or conditions, the following derivation leads to the sample estimator of ρ_{πP}² in Equation (15).

In Equation (5), μ_{P}, equal to 1/K, is the population as well as the sample mean proportion so that S_{P}² with K rather than (K−1) in the denominator, is an unbiased estimator of σ_{P}²:

$${σ}_{P}^{2} = {E}_{t} ( ( \frac{1}{K} ) {\sum }_{k = 1}^{K} {( {P}_{kt} - {μ}_{P} )}^{2} ) \qquad ( 6 )$$

If πₖ=μ_{π}+δₖ, where (1/K)Σₖ₌₁^{K}δₖ=0, then σ_{π}²=(1/K)Σ_{K=1}^{k}δ_{K}². As noted in the preceding section, Pₖₜ=πₖ+∈ₖₜ. The expected values of ∈ₖₜ and δₖ∈ₖₜ (equal to δₖ times the expected value of ∈ₖₜ) are equal to zero. Substitution first of πₖ+∈ₖₜ for Pₖₜ and then of μ_{π}+δₖ for πₖ in Equation (6) thus, with μ_{π}=μ_{P}, leads to

$${σ}_{P}^{2} = {σ}_{π}^{2} + ( \frac{1}{K} ) {\sum }_{k = 1}^{K} {σ}_{ϵ k}^{2} \qquad ( 7 )$$

where, for each option k, σ_{∈k}² is the sampling variance

$${σ}_{ϵ k}^{2} = ( \frac{1}{n} ) {π}_{k} ( 1 - {π}_{k} ) \qquad ( 8 )$$

Substitution of μ_{π}+δₖ for πₖ in the computation of the mean of Equation (8) over the K values of σ_{∈k}² produces

$$\frac{1}{K} {\sum }_{k = 1}^{K} {σ}_{ϵ k}^{2} = \frac{{μ}_{k} ( 1 - {μ}_{k} )}{n} - \frac{{σ}_{π}^{2}}{n} \qquad ( 9 )$$

since Σₖ₌₁^{K}μ_{π}δₖ=μ_{π}Σₖ₌₁^{K}δₖ=0 and Σₖ₌₁^{K}δₖ²=Kσ_{π}², Equation (7) thus becomes

$${σ}_{P}^{2} = {σ}_{π}^{2} + \frac{{μ}_{π} ( 1 - {μ}_{π} )}{n} - \frac{{σ}_{π}^{2}}{n} \qquad ( 10 )$$

or, with 1/K for μ_{π},

$${σ}_{P}^{2} = {σ}_{π}^{2} + \frac{K - 1}{{nK}^{2}} - \frac{{σ}_{π}^{2}}{n} \qquad ( 11 )$$

Solution of Equation (11) for σ_{π}² finally yields the expression of σ_{π}² in terms of σ_{P}²:

$${σ}_{π}^{2} = ( \frac{n}{n - 1} ) {σ}_{P}^{2} - ( \frac{K - 1 )}{n - 1} ) {( \frac{1}{K} )}^{2} \qquad ( 12 )$$

The formula for ρ_{πP}² is thus

$${ρ}_{π P}^{2} = \frac{( \frac{n}{n - 1} ) {σ}_{P}^{2} - ( \frac{K - 1 )}{n - 1} ) {( \frac{1}{K} )}^{2}}{{S}_{P}^{2}} \qquad ( 13 )$$

so that the estimator of ρ_{πP}² is

$${\hat{ρ}}_{π P}^{2} = \frac{( \frac{n}{n - 1} ) {S}_{P}^{2} - ( \frac{K - 1 )}{n - 1} ) {( \frac{1}{K} )}^{2}}{{S}_{P}^{2}} \qquad ( 14 )$$

or, since S_{P}² =(1/K)Σₖ₌₁^{K}Pₖ²−(1/K)²,

$${\hat{ρ}}_{π P}^{2} = 1 - \frac{K ( 1 - {\sum }_{k = 1}^{K} {P}_{kt}^{2} )}{( n - 1 ) ( K {\sum }_{k = 1}^{K} {P}_{kt}^{2} - 1 )} \qquad ( 15 )$$

where Σₖ₌₁^{K} Pₖₜ² is the sum of the squares of the K proportions computed from the sample t of size n. Equation (14) shows that \hat{ρ}_{πP}² is not only an increasing function of S_{P}² , K, and n but also an unbiased estimator of ρ_{πP}², the S_{P}² in the denominator being fixed.

Step Three—Point Estimation: Estimation of π for P

The regressions underlying the developments in this and the preceding section are opposite in direction. Both involve P and π. The development in the preceding section considered π as fixed and P as variable. In the development here, however, the reverse is true: P is fixed, and π is variable. In this development, the fixed-Pₖ sample (k=1, 2, . . . , K) comes from a single population, which is one of any number of possible populations, with their correspondingly different πₖ values. Although the expected value of variable Pₖ is πₖ, the expected value of a variable πₖ is not Pₖ, but a value \hat{π}ₖ somewhere between Pₖ and 1/K. Whereas the direction of regression assumed in the proceeding section worked for the development of a formula for \hat{ρ}_{πP}², the regression direction taken here is particularly appropriate for the estimation of an unknown πₖ, assumed variable, from a known Pₖ, assumed fixed for each option k:

$${\hat{π}}_{k} = {ρ}_{π P} ( \frac{{σ}_{P}}{{S}_{P}} ) {P}_{k} - {ρ}_{π P} ( \frac{{σ}_{P}}{{S}_{P}} ) \overline{P} + {μ}_{π} \qquad ( 16 )$$

where \hat{π}ₖ is the regression estimate of πₖ, ρ_{πP} is the correlation between Pₖ and πₖ for the population sampled from, and μ_{P} and μ_{π} are the means and S_{P} and σ_{π} are the standard deviations over options of Pₖ and πₖ, respectively. Since ρ_{πP}²=σ_{π}²/S_{P}², this equation simplifies to

\hat{π}ₖ=ρ_{π}P²Pₖ−ρ_{πP}²P̅+μ_{π} (17)

where μ_{π} is equal to P̅ so that, with both μ_{π} and P̅ denoted by μ,

\hat{π}ₖ=ρ_{πP}²Pₖ+(1−ρ_{πP}²)μ (18)

or, since μ=1/K,

$${\hat{π}}_{k} = {ρ}_{π P}^{2} {P}_{k} + \frac{1 - {ρ}_{π P}^{2}}{K} \qquad ( 19 )$$

Estimation of the population proportion πₖ corresponding to the observed proportion Pₖ thus requires knowledge only of ρ_{πP}². If ρ_{πP}²=1, \hat{π}ₖ=Pₖ; if ρ_{πP}²=0, \hat{π}ₖ=1/K. Generally, in practice, \hat{π}ₖ will be somewhere between Pₖ and 1/K.

Since Pₖ is assumed fixed, substitution of \hat{ρ}_{πP}² for ρ_{πP}² in Equation (19) yields an estimate of πₖ that is not subject to sampling variation.

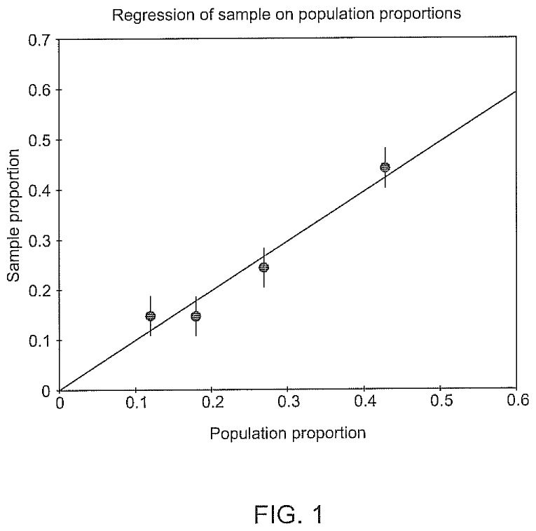

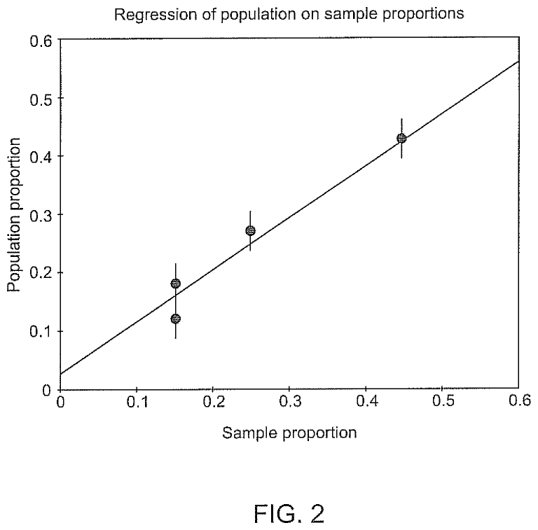

FIG. 1 illustrates the regression of P on π and FIG. 2 the regression of π on P. In both figures, the population proportions are fictitious since their actual values are unknown. Knowledge of these values is unnecessary because the only requirements for estimation are the sample proportions in FIG. 1 and the regression line in FIG. 2. The vertical lines define 95% confidence intervals. Based on n=100, the value of \hat{ρ}_{πP}² is 0.88, the slope of the regression line in FIG. 2. In addition to their different slopes, the two regression lines notably have different intercepts: 0 in FIG. 1 and 0.03 in FIG. 2. Except when \hat{ρ}_{πP}²=1, π-on-P regression produces population-proportion estimates that are greater than zero and less than one.

Two examples provide data to illustrate the π-on-P regression procedure. The first, cited by Tull and Hawkins (1993, pp. 745-746) in the spirit of R. A. Fisher's classic tea-testing illustration of the Student t-test, was a Carnation taste test comparing Coffee-mate to real cream. Of 285 participants who claimed to be able to distinguish between two cups of coffee presented them, one containing Coffee-mate and the other containing cream, 153 were correct and 132 were incorrect, the corresponding proportions being 0.54 and 0.46. With \hat{ρ}_{πP}²=0.42, the Bayesian-estimated proportions were 0.52 and 0.48, respectively. These proportions more strongly than their frequentist counterparts support the conclusion that people could not tell the difference between Coffee-mate and real cream.

In the second example, a large school district tested three different textbooks for first-year high school algebra. The first was the book used for the past several years; the second and third were new books containing questions taken from recent versions of a statewide mathematics examination. The question format differed in these books, being open-ended in the second book and multiple-choice (as in the statewide examination) in the third book. Two hundred students in different classes used each book. Of the 450 students who passed the statewide examination, 130 had used the first book, 158 the second book, and 162 the third book. The corresponding proportions were 0.29, 0.35, and 0.36, respectively. Substituting these proportions, which sum to 1.00, in Equation (13), together with K=3 and n=450 yields 0.48 for the value of \hat{ρ}_{πP}², and using this value for \hat{ρ}_{πP}² in Equation (19) yields \hat{π}ₖ values of 0.31, 0.34 and 0.35 for the three books, respectively. The first and third values notably differ (by 0.02 each) from their uncorrected counterparts while the second, being closer to the mean of 0.33, shows a difference of only 0.01, to two decimal places. If the books had been equally effective, the expected proportions within the passing group would be equal to 0.33 for students using all three books.

### Step 4A—Interval Estimation: Two-option Case

Reported survey results often include half the size of the 95% confidence interval as the so called “margin of error.” For K=2, the procedures developed in this embodiment of the invention involve intervals different from the conventional ones. The confidence or credibility intervals appropriate for the K=2 procedures developed here are functions of the standard error of measurement, applicable to the regression of P on π, or the standard error of estimate, applicable to the regression of π on P (Kelley, 1923, 1927). Both standard errors involve the assumption of homoscedasticity: Values of the standard errors of measurement are equal for all values of πₖ, and values of the stand and error of estimate are equal for all values of Pₖ (k=1, 2, 3, . . . , K). In the case of proportions, as opposed to means of multi-valued variables, this assumption makes sense only when K=2.

Though of less practical value, the standard error of measurement, σ_{P-π}=S_{P}\sqrt{1−ρ_{πP}²}, produces confidence intervals directly comparable to the conventional ones. Estimates of σ_{P-π} are obtainable by using \hat{ρ}_{πP}² for ρ_{πP}² in the formula for σ_{P-π}.

The Carnation data provide an example. The two observed proportions, 0.54 and 046, were inaccurate by an amount equal to ±0.06. As the conventional 95% margin of error, this value (0.06) is 1.96 times \sqrt{0.5(1−0.5)/285}. Use of the standard error of measurement would produce a 95% confidence interval of the same size, to two decimal places. Substituting the value of 0.04 for S_{P} and the \hat{ρ}_{πP}² value of 0.42 for ρ_{πP}² yields σ_{P-π}=0.03, or (multiplying 0.03 by 1.96) a 95% error margin of ±0.06.

Confidence intervals determined from the standard error of measurement are directly comparable to conventionally determined confidence intervals because both are based on the assumption of a fixed π and a variable P. The standard error of estimate, applicable in the regression case of a fixed P and a variable π, has the same formula as the standard error of measurement with the exception that σ_{π} replaces S_{P}: σ_{\hat{π}-π}=σ_{π}\sqrt{1−ρ_{πP}²}. Since ρ_{πP}²=σ_{π}²/S_{P}², the standard error of estimate will, except when ρ_{πP}² =1, be smaller than the standard error of measurement by a factor of ρ_{πP}. Conceptually, the standard error of estimate should be smaller than the standard error or measurement because the difference (P−π) contains a varying component representing bias that is absent in the difference (\hat{π}−π). Credibility intervals for a variable π will therefore generally be smaller than corresponding confidence intervals for a variable P. When K=2, the estimate of σ_{\hat{π}-π}, corresponding to σ_{p-π}, is equal to the estimate of σ_{p-π}, multiplied by \hat{ρ}_{πP}.

In the Carnation example, with \hat{ρ}_{πP}²=0.42, the standard error of estimate is \sqrt{0.42} times 0.03 (the standard error of measurement), or 0.019, so that the 95% margin of error (1.96 times 0.019) is ±0.04. This (rounded from 0.037) is considerably smaller than the conventional error margin of ±0.06. The sample of 285 would, in fact, have to be 417 larger (a total of 702 respondents) to achieve the same ±0.04 margin of error conventionally. Since both the confidence and the credibility intervals overlap the chance proportion of 0.50, the data do not support the claim that tasters can tell cream from Coffee-mate.

For the ±credibility interval to be comparable to the conventional ±0.06 confidence interval, it must also contain 95% of the area under its frequency curve. The next section will investigate the extent to which this is the case not only here but also more generally.

Question—Do ±1.96 Standard Errors Constitute 95% Credibility Intervals in π-on-P Estimation?

The answer, generally, is yes, as this section demonstrates.

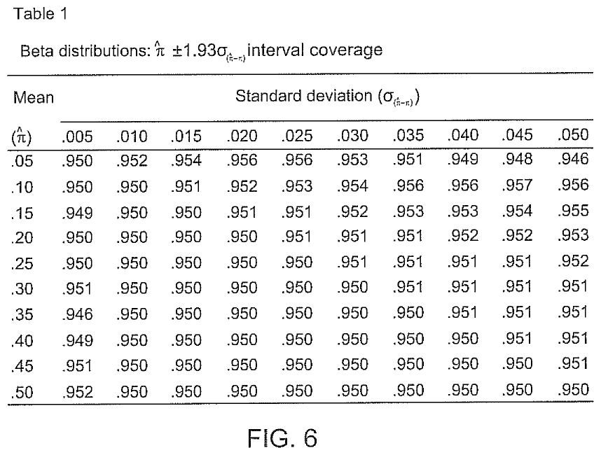

Corresponding to the assumption of a binomial distribution for sample proportions is the assumption of a beta distribution for population proportions. One distribution is the conjugate of the other. Dirichlet distributions are correspondingly conjugates of multinomial distributions. Such assumptions of conjugate distributions are common in Bayesian analysis (e.g., Good, 1965, Chapter 3). Under the beta-distribution assumption, not only does the ±0.04 credibility interval of the Carnation example contain 95% of the area under its frequency curve but also, as FIG. 6 shows, ±1.96σ_{\hat{π}-π} credibility intervals ranging from ±0.01 to ±0.1 of point estimates (\hat{π}) between 0.05 and 0.50 will generally contain 95% of possible π values. (No subscript for π is necessary here because a beta distribution involves only two proportions, π and 1−π) The coverage shown in FIG. 6 is based on calculations, not Monte Carlo sampling. FIG. 6 shows confidence-interval proportions for values of \hat{π} not only between 0.05 and 0.50 but also, though indirectly, between 0.50 and 0.95. Because beta distributions having mean values between 0.50 and 0.95 are mirror images of beta distributions having mean values between 0.05 and 0.50, the credibility-interval proportion of \hat{π} is equal to the credibility-interval proportion for 1−\hat{π}, provided that both distributions have equal standard deviations (σ_{\hat{π}-π}).

FIG. 6 shows credibility-interval proportions as a function of beta-distribution means and standard deviations because these are the parameters involved in the determination of credibility intervals. Beta distributions, however, are functions of two parameters, a and b, related to beta-distribution means (\hat{π}) and standard deviations (σ_{\hat{π}-π}), as follows:

a=\hat{π}(a+b) (20)

and

b=(1−\hat{π})(a+b) (21)

where

$$a + b = \frac{\hat{π} ( 1 - \hat{π} )}{{σ}_{\hat{π} - {π}^{2}}} - 1 \qquad ( 22 )$$

For the Carnation data, a+b=0.52(1−0.52)/(0.019)²−1, or 690, so that a=0.52(690), or 359, and b=(1−0.52)690, or 331, and for these values of a and b the interval between 0.52−1.96(0.019) and 0.52+1.96(0.019) contains 95% of the area under the beta-distribution frequency curve. FIG. 6 shows this result in the row for 0.50 (close to 1−0.52) and the column for 0.020 (close to 0.019).

The two standard errors, the standard error of measurement and the standard error of estimate, differ not only in the lengths of the confidence or credibility intervals that they produce but also in one other important respect: While the standard error of measurement, computed from S_{P} and \hat{ρ}_{πP}² (itself a function of S_{P}), is subject to sampling variation due to the possible variation of P for each option over samples, the standard error of estimate does not change because under the π-on-P assumption governing its use each P remains constant while only π can change for each option. In both these respects, the standard error of estimate is superior to the standard error of measurement for use in the determination of credibility or confidence intervals for population proportions.

The results shown in FIG. 6 are applicable to Dirichlet as well beta distributions because a beta distribution describes each Dirichlet proportion if all the other proportions are aggregated as its complement.

### Step 4B—Interval Estimation: Case of Two or More Options

The standard error of estimate provides the basis for a common credibility interval, applicable particularly for proportions when K=2. The assumption of a Dirichlet prior distribution for the population proportions makes possible the determination of a different interval for each proportion when K≥3. (When K=2, the two intervals are the same.) If τ designates the total of the parameters of a Dirichlet distribution, then the posterior variance of πₖ for option k is

$$Var ( {π}_{k} \vert {P}_{k} ) = \frac{{\hat{π}}_{k} ( 1 - {\hat{π}}_{k} )}{τ + n + 1} \qquad ( 23 )$$

where Pₖ is the observed proportion for option k. Use of this equation, with \hat{π}ₖ from Equation 19 estimating the expected value of πₖ, requires knowledge of τ.

Since

$$E ( {π}_{k} \vert {P}_{k} ) = \frac{{k}_{} + {nP}_{k}}{τ + n}$$

for a Dirichlet distribution, the Direchlet shrinkage coefficient corresponding to \hat{ρ}_{πP}² here is n/(τ+n), and so for the π-on-P procedure

$${τ}_{π \vert P} = \frac{n ( 1 - {\hat{ρ}}_{πP}^{2} )}{{\hat{ρ}}_{π P}^{2}} \qquad ( 24 )$$

or, from Equation 15,

$${τ}_{π \vert P} = \frac{K ( 1 - {\sum }_{k = 1}^{K} {P}_{k}^{2} )}{K {\sum }_{k = 1}^{K} {P}_{k}^{2} - 1 - \frac{K - 1}{n}} \qquad ( 25 )$$

According to Fienberg and Holland (1973), the minimax value of τ is \sqrt{n} and the maximum-likelihood estimator of τ is

$${τ}_{π \vert P} = \frac{K ( 1 - {\sum }_{k = 1}^{K} {P}_{k}^{2} )}{K {\sum }_{k = 1}^{K} {P}_{k}^{2} - 1} \qquad ( 26 )$$

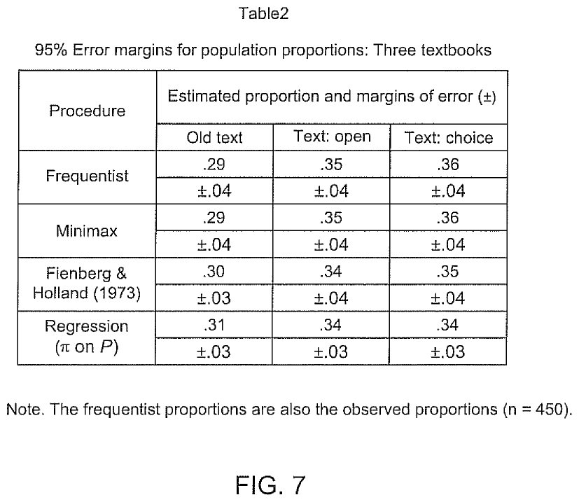

Using the values of τ computed from Equations (25) and (26) as well as \hat{π} in Equation (23) with data from the three-textbook example presented earlier produced the 95% credibility or confidence intervals in FIG. 7, which includes corresponding traditional, frequentist results.

FIG. 7 shows separate error margins for the three different textbook groups, as well as their different population-proportion estimates under the four different procedures, corresponding in the case of the non-frequentist procedures to their different values of τ: 21, 232, and 487, respectively, for minimax, Fienberg and Holland, and π-on-P. The π-on-P procedure produced the narrowest margins of error. This result is not surprising since, as Equations (25) and (26) make clear, the τ_{π|P} for the π-on-P procedure is greater than the τ_{π|P} for the maximum-likelihood procedure, the difference diminishing as n gets large. According to Equation (24), the T for the minimax procedure (\sqrt{n}) will also be smaller than the τ_{π|P} for the π-on-P procedure unless \hat{ρ}_{πP}²/(1−\hat{ρ}_{πP}²) ≥\sqrt{n}, which is not the case here. Since the standard error of the three non-frequentist procedures ranged between 0.01 and 0.02, the credibility intervals, as FIG. 6 shows, all have approximately 95% coverage.

Depending on which of the four estimation procedures they use, investigators looking at the study's result might come to entirely different conclusions. Since 0.33 bordered or lay outside the confidence or credibility interval of the older textbook in all but the π-on-P procedure, investigators using the three other procedures might conclude that the older textbook was less effective than the two new ones. An investigator using the π-on-P procedure, however, would not reach that conclusion. All three credibility intervals produced by that procedure, despite being generally narrower than the other by 0.02, contain the chance proportion 0.33. The conclusion following from this result is that further study is necessary before selecting a textbook for general use.

### Comparison of Bayesian and Frequentist Procedures in the Two-option Case

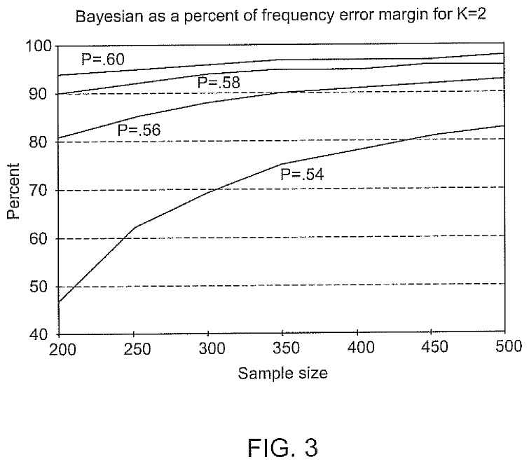

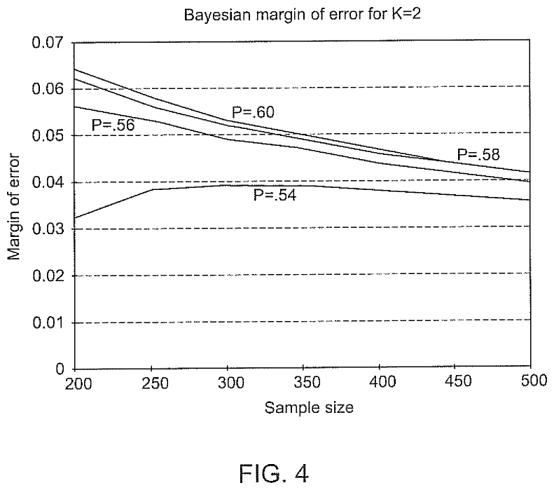

FIGS. 3 and 4 provide a broader view of the frequentist and Bayesian (π-on-P) regression procedures. Limited to K=2, these figures show, for a range of sample sizes and P values, Bayesian margins of error as percent's of frequentist margins of error (FIG. 3) and actual Bayesian margins of error (FIG. 4). The three high curves in each figure represent high \hat{ρ}_{πP}² values, approaching one for n=500, while the bottom curve (for P=0.54) represents a comparably low \hat{ρ}_{πP}² value. When \hat{ρ}_{πP}² is high, Bayesian and frequentist margins of error are very nearly equal, as are corresponding point estimates; when \hat{ρ}_{πP}² is low, Bayesian margins of error are low and point estimates are close to the mean, relative to their frequentist counterparts. For P values that are very close to the mean, A \hat{ρ}_{πP}² can be so low that Bayesian point estimates are for all practical purposes equal to the mean, with margins of error effectively equal to zero. This is the case for P=0.52 when n≤500.

Is π-on-P an Empirical or a Purely Bayesian Procedure?

In regressing the observed proportion P toward the mean, 1/K, the squared correlation \hat{ρ}_{πP}² resembles the shrinkage coefficient w in Fienberg and Holland (1973) or 1−B in Efron and Morris (1973) and Morris (1983). Because the development using w or 1−B involves empirical Bayesian estimation, this resemblance suggests that π-on-P regression may also be empirical Bayesian. This is not the case, however.

The π-on-P procedure is a regression, not an empirical Bayesian, procedure. The difference is important. While estimates in both the π-on-P and the Fienberg and Holland (1973) procedures are expected values of it given P, both π and P may vary in empirical Bayesian estimation while only it may vary in estimation by π-on-P regression. If P as well as π were to vary in π-on-P regression, then the credibility intervals computed from the standard error of estimate would be too small, as the coverage proportions in FIG. 6 would be too large. The more apt comparison is with pure Bayesian estimation because in both this and π-on-P regression P is fixed while only π may vary. Because the regressed-on variables are fixed in regression estimation, the coverage proportions in Table 1 and their corresponding credibility intervals are accurate.

### Shrinkage Coefficients as Slope Coefficients in Regression

Shrinkage coefficients may be interpretable as slope coefficients in regression. Stigler (1990) made this observation in relation to the work originated by James and Stein (1961), involving means. The squared correlation ρ_{πP}² is in fact the single-sample binary (0-1) data counterpart to the multi-sample shrinkage coefficient 1−B cited by Morris (1983) under the empirical Bayes assumption of normal distributions for both sample and population means. If form samples, with m>2, σ_{X̅−μ}² and σ_{π}² are the respective variances of these distributions, then according to Morris, 1−B=σ_{μ}²/(σ_{μ}²+σ_{X̅−μ}²), which is the square of the correlation between μ and X̅. In view of Equations (23), (25), and (26), the shrinkage coefficient w in the Fienberg and Holland (1973) procedure is a consistent estimator of the squared correlation between π and P, the shrinkage coefficient developed here (\hat{ρ}_{πP}²) being an unbiased estimator of it.

In the James-Stein case, σ_{X̅−μ}²=1, so that the risk function of the traditional estimator X̅ is equal to one for each value of μ. Ifμ has a normal distribution, then the posterior variance of μ given X̅ is equal to 1−B and, as Efron and Morris (1973) observed, the risk function of the estimator (1−B)X̅, which is the posterior mean of μ given X̅ assuming μ to have a mean of zero, is smaller than the risk function of X̅ by an amount equal to B. The estimator (1−B)X̅ is the James-Stein estimator if B is replaced by (m−2)Σᵢ₌₁^{m}X̅ᵢ², whose expected value is equal to B because, with σ_{X̅−μ}²=1 and 1/B the variance of X̅, Σᵢ₌₁^{m}X̅ᵢ²has a χ²ₘ distribution with negative first moment equal to 1/(m−2). The James-Stein shrinkage coefficient 1−(m−2)Σᵢ₌₁^{m}X̅ᵢ² is thus interpretable as an unbiased estimator of the square of the correlation between μ and X̅, or as an unbiased estimator of the slope coefficient in the regression of μ on X̅, the intercept being equal to zero.

Since \hat{ρ}_{πP}² is also an unbiased estimator, it corresponds in single-sample proportions estimation to the James-Stein shrinkage coefficient in multi-sample means estimation.

### Bayesian Versus Conventional Margins of Error in the Estimation of Population Proportions

So far, this presentation has shown that the regression of population on sample proportions constitutes Bayesian estimation of population proportions, while demonstrating how to perform this estimation on existing data. To apply this procedure to the conduct of a survey, what is needed is a method to determine the sample size n required to achieve a desired margin of error. In conventional or classical estimation, the method involves the use of a simple formula: n=0.96/m²′ where m designates the desired margin of error. For a margin of error equal to 0.03, for example, n=0.96/(0.03)²′ or 1,067. Unfortunately, in Bayesian estimation, no such simple formula for n exists. This invention uses simulation to resolve that problem. The simulation requires an equation for ρ_{πP}² in terms of m and n. Since from Equation (19) σ_{\hat{π}}²=ρ_{πP}⁴S_{P}² and since from Equation (4) S_{P}²=σ_{π}²ρ_{πP}² so that S_{P}²=σ_{\hat{π}}²/ρ_{πP}² and since

$${σ}_{\hat{π}}^{2} = \frac{{\hat{π}}_{1}^{2} + {\hat{π}}_{3}^{2}}{2} - \frac{1}{4} = \frac{{( .5 + m )}^{2} + {( .5 - m )}^{2}}{2} - \frac{1}{4} = {m}^{2} \qquad ( 27 )$$

for K=2, substitution of m²/p_{πP}², for S_{P}² in Equation (14) with K=2 and solving for ρ_{πP}² yields

ρ_{πP}²=2({square root over ((n−1)m²)²+nm²)}−(n−1)m²) (28)

The relationship between σ_{\hat{π}}² and σ_{π}² is notable: Substitution of S_{P}²=σ_{π}²/ρ_{πP}² for S_{P}² in σ_{\hat{π}}²=ρ_{πP}⁴S_{P}², and solving for σ_{π}² shows that σ_{π}²=σ_{\hat{π}}²/ρ_{μP}² or, with m² for σ_{\hat{π}}², σ_{π}²=m²/ρ_{μP}². Now, computation of 1.645(σ_{\hat{π}-π}) with σ_{\hat{π}-π}equal σ_{π}\sqrt{1−ρ_{πP}²} and σ_{π}=m/ρ_{πP} for successively larger integer values of n, beginning with the conventional value of n for m, continues until 1.645(σ_{\hat{π}-π}) is equal to m. The value of n yielding this result is a sample size for which the null value, 0.50 for K=2, will be outside the margin of error when it is at a distance equal to or greater than m from \hat{μ}. Generally, for K≥2, replacement of m by M equal to m+1/K−0.5 in the simulation process will yield a value of n for which a \hat{π}ₖ≥1/K+m or πₖ≤1/K−m would be outside the margin of error.

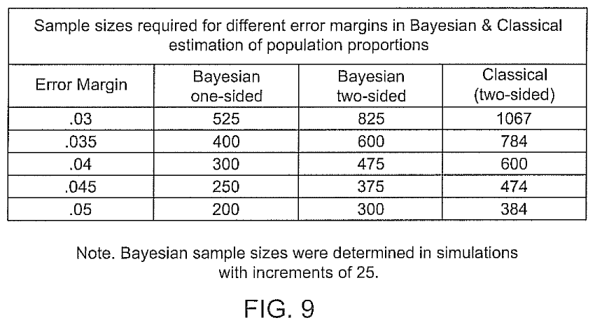

Why does the simulation use 1.645 instead of 1.96, as in conventional estimation? In conventional estimation, the margin of error is the distance between two boundaries that contain between them 95 percent of outcomes that could occur by chance. That is necessary because in this estimation the chance outcomes could occur with equal probability on either side of the null population value (equal to 0.50 when estimating probabilities with K=2). The occurrence of an observation outside the error margin nullifies that population value (meaning, when K=2, it is not equal to 0.50). The same necessity does not exist in Bayesian estimation, however, because in this case the observed value is considered fixed, meaning it cannot be on the other side of the null value, and the error margin needs only a boundary between it and the null value, the distance between the estimated value and the boundary being the margin of error (0.03, for example). Nullification occurs when the null value (0.50 when K=2) is outside this error margin. A one-sided error margin has a distinct advantage over a two-sided one, which divides the 5 percent nullification values into two equal 2.5 percent parts, one on either side. In the case of a one-sided error margin, all the 5 percent nullification values are on one side, the side where the null value is. A sample that has 5 percent of nullification values on a single side of an error-margin boundary must be smaller than one that has 2.5 percent there. That means a smaller sample will produce any desired margin of error in the one-sided than in the two-sided case. This sample-size advantage is in addition to the one that Bayesian estimation has even in the case of two-sided error margins. FIG. 9 provides an illustration for selected margins of error when K=2.

So far, in the determination of sample size for a Bayesian estimate, this patent has focused on proportions. The processes described in the paragraphs between [0027] and and in paragraphs [0061] and [0062] can also apply to means, with X̅ₖ replacing P_{K} and θₖ replacing πₖ, k standing for a sample instead of an option, and all measurements in the K samples together being converted to have a mean of zero, with appropriate changes in the equations of those paragraphs, such as (1/n)θₖ² replacing (1/n)πₖ(1−πₖ) in Equation (8), where θₖ=X̅ₖₜεₖₜ. For the equations in paragraphs [0061] and [0062], the desired margin of error for sample k would be equal to the distance between the Bayesian estimate of θₖ and zero, which is the mean of θ over samples. This development for means, in which K can be greater than or equal to two, differs from the James-Stein development not only because theirs is empirical Bayes and this one is pure Bayes but also because theirs does not involve margins of error and samples sizes, the intent in their development being only to show the extent to which their estimation method could produce a smaller error variance than conventional, classical estimation in cases involving three or more samples having equal values of n.

### The Determination of True Measurements in Mental Testing

In other embodiments of the regression of a true measurement on an observed measurement to be described below, the true measurement may be the probability of a correct response to an item by a particular person and the observed measurement may be an actual response by that person to that item. The probability of a correct response regressed on an observed measurement may be implemented in a delta single-parameter logistic modeling technique. Delta single-parameter logistic modeling includes receiving a response for each item and each test taker, and a total score for each test-taker. The correlation between the item response and the total test score or other ability measure over the plurality of test-takers is determined. A Bayesian-estimated probability of a correct response for each test-taker to each item is determined. The logit of this probability estimate is determined. The difficulty of an item is estimated as a function of the average logit over the number of test-takers. A test-taker's ability is likewise estimated as a function of the average logit and the average difficulty over the number of test items.

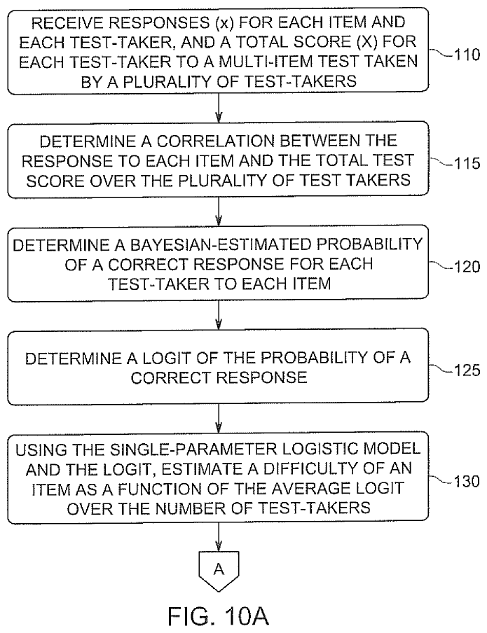

Referring now to FIGS. 10A and 10B, a delta single-parameter logistic modeling method, in accordance with a number of embodiments of the present technology, is shown. It is appreciated that method may be implemented in hardware, software, firmware and/or a combination thereof. The method may begin with receiving correct or incorrect item responses (x) for each test taker and each test item, and a total test score (X) for each test-taker, at 110. In one implementation, the test may be a multi-item test taken by a plurality of test takers. In one implementation, the value of the response (x) may be 1 if correct and 0 if incorrect.

At 115, a correlation (p) between the item response (x) and the total test score (X) over the plurality of test takers is determined. The correlation (p) incorporates item discrimination, which is the extent to which an item measures what it is supposed to measure (what the test as a whole measures). At 120, an initial Bayesian estimate of the probability (P) of a correct response for each test-taker to each item is determined as the weighted average of x and the proportion of test-takers who answer the item correctly, wherein the weights are ρ² for x and one minus ρ² for the proportion of test-takers who answer the item correctly.

At 125, a logit (λ) of the probability (P) is determined, wherein the logit of a probability is the natural logarithm of the ratio of the probability to it complement (i.e., one minus the probability). At 130, a difficulty of an item is estimated as minus the average logit (λ) over the number of test-takers. At 135, a given test-taker's ability (θ) is estimated as the sum of the average difficulty (b) and the average logit (λ) over the number of test items. At 155, the difficulty of the item and the test-taker's ability are output. In one implementation, the results may be output by storing on a computing device readable medium (e.g., computer memory), displaying on a monitor (e.g., computer screen), and/or the like.

At 140, the processes of 115-135 may optionally be iteratively repeated, replacing the correlation between item response and total test score with the correlation between item response (x) and test-taker ability (θ), one or more times or until a change in the given test-taker's ability (θ) is less than a predetermined amount. In one implementation, the processes of 115-135 may be iteratively repeated until no estimate of given test-taker's ability (θ) differs from its estimate on the preceding cycle by more than 0.004. In such an implementation, a given test-taker's ability (θ) estimates are used until they settle into stable values, when the iterative process ends.

At 145, new difficulty (b) estimates for use in item banks and test-form equating may optionally be determined using a simple Rasch model. At 150, the process is to retain these Rasch b estimates while adding their average to each θ estimate obtained in processes 115-140 and subtracting from it the average b estimate obtained in these processes (115-140).

The processes of 115-135 are referred to herein as the delta single-parameter logistic model. The processes of 115-140 implement the delta single-parameter logistic model providing an improved test-taker's ability (θ). The processes of 115-150, which combine the delta single-parameter logistic model for the test taker's ability (θ) and the Rasch model for the item difficulty (b), is referred to herein as the hybrid model.

Embodiments of the present technology will be further elucidated in the following description, which will begin with data adjustment, moving from the test level to the item level via the point-biserial correlation r_{xX} between item response (x) and test score (X). In classical test theory, this correlation, with the difference between the mean test score of examinees who get the item right and the mean test score of examinees who get the item wrong in the numerator (McNemar, 1962, p. 192), not only measures but in fact captures the precise meaning of item discrimination. The section following the next will describe parameter estimation in the fit of the Rasch model to item-response data adjusted by r_{xX} (Throughout this description, lower-case x will refer to an item and upper-case X to a test.)

Logits: Observed Scores vs. True-score Estimates

The logit of a proportion or probability P is the natural logarithm of the ratio of P to (1−P). If P_{iq} is the probability of a correct response to item i by examinee q, then for a two-parameter logistic model the logit of P_{iq} is equal to aᵢ(θ_{q}−bᵢ). The next section will need an empirical counterpart of P_{iq} that has a computable logit. In the Gulliksen version of classical test theory, the observed response x_{iq}, equal to zero or one, qualifies as such a counterpart, but x_{iq} has no computable logit. The Kelley version of classical test theory suggests a solution to this problem: a weighted average of an observed score and the observed score mean for a single item,

p_{iq}=r_{xX}²x_{iq}+(1−r_{xX}²)x̅ᵢ (27)

where x̅ᵢ is the item difficulty, equal to the mean of x_{iq} over q, and r_{xX}, as noted earlier, is a measure of item discrimination. Unless r_{xX} is equal to one, which is not possible for a point-biserial correlation, or x̅ᵢ is equal to zero or one, P_{iq}will always have a computable logit.

The use of p_{iq} rather than x_{iq} as the empirical counterpart of P_{iq} makes rational as well as mathematical sense, especially for multiple-choice items. On a zero-to-one scale, the value of one is arguably too large a measure for a correct item response in this case. Not only may the knowledge or skill measured by an item be at least partially irrelevant but also a correct response does not necessarily reflect that knowledge or skill. Guessing may play a role. The effect of guessing, however, also depends on the item's discrimination. An examinee who gets the item right is more likely to have a high test score and thus be more generally knowledgeable on the subject tested if the item is highly discriminating than otherwise. This difference is properly reflected in the value of p_{iq}. If x_{iq}=1 for each of two items that vary in discrimination, the value of p_{iq} will be closer to one for the more discriminating than for the less discriminating item. A like argument applies in the case of incorrect answers to the two items. A correct answer has a greater positive effect and an incorrect answer a greater negative effect on p_{iq} if made to a more discriminating than to a less discriminating item in contrast to the uniformly equal positive and negative effects on x_{iq}. For a multiple-choice item and arguably for any item scored on a zero-to-one scale, p_{iq}will generally be a more precise reflection of relevant item knowledge than x_{iq}.

### Fitting the Model to Data

Transformation of the single-parameter logistic model of Equation (1) to a logit form permits the accommodation of item discrimination and difficulty in model fit. With the addition of the indices i and q, Equation (1) has the logit form

$$ln ( \frac{P ( {θ}_{q} ; {b}_{i} )}{1 - P ( {θ}_{q} ; {b}_{i} )} ) = {θ}_{q} - {b}_{i} \qquad ( 28 )$$

the left side corresponding empirically to ln(P_{iq}/[1−P_{iq}]), the logit of p_{iq}. If λ_{iq}=ln(P_{iq}/[1−P_{iq}]), then empirically the logit form of the single-parameter logistic model is a regression equation like X=T+E of classical test theory, ϵ_{iq} denoting error:

λ_{iq}=(θ_{q}−bᵢ)+ε_{iq} (29)

so that, as ordinary least-squares estimates assuming the average θ to be equal to zero,

\hat{b}ᵢ=−λ̅ₗ (30)

and

\hat{θ}_{q}=λ̅_{q}+b̅ (31)

λ̅ₗ being the mean of λ_{iq} over q, λ̅_{q} the mean of λ_{iq} over i, and b̅ the mean item difficulty. All computation of item statistics in this and subsequent sections are over q.

Since \hat{b}ᵢ is a mean and θ_{q} a sum of means, estimates of their sampling variances are, respectively,

$$\begin{matrix}{\hat{σ}}_{{b}_{i}}^{2} = \frac{{\sum }_{q = 1}^{N} {( {λ}_{iq} - {\overline{λ}}_{i} )}^{2}}{N ( N - 1 )} & ( 32 ) \\ and & \\ {\hat{\hat{σ}}}_{{θ}_{q}}^{2} = \frac{{\sum }_{i = 1}^{n} {( {λ}_{iq} - {\overline{λ}}_{q} )}^{2}}{n ( n - 1 )} + \frac{{\sum }_{i = 1}^{n} {\hat{σ}}_{{b}_{i}}^{2}}{{n}^{2}} & ( 33 )\end{matrix}$$

Despite their apparent equivalence, differing only by a scale conversion, [symbol] _{q} and ( [symbol] _{q}−bᵢ) cannot both be true scores, like T. Just as a true score in classical test theory must be both test- and examinee-dependent, so a true score for an item in modern test theory must be both item- and examinee-dependent. This is the case for ( [symbol] _{q}−bᵢ), but not for [symbol] _{q}, which is only examinee-dependent, though both θ_{q} and ( [symbol] _{q}−bᵢ) have equal standard deviations and correlations with other variables.

For a single sample, in fact, the correspondence between T and θ_{q}−bᵢ is striking if, following common practice, the mean of θ is assumed to be zero. In this case, just as the mean of T (T̅), being equal to the proportion of examinees (X̅) who get the item right, is the measure of item difficulty in classical test theory, so the mean of θ_{q}−bᵢ over examinees is equal to minus the measure of item difficulty (bᵢ) in modern test theory. While X̅ decreases, minus the mean of θ_{q}−bᵢ over examinees increases with increasing item difficulty.

The accommodation of varying item discrimination by using the true-response estimates p_{iq} to estimate bᵢ and θ_{q} occurs without the use of the parameter αᵢ. The resulting single-parameter logistic model retains the parameter-separation but not the unweighted-scores property of the Rasch model, a price paid for by the accommodation of varying item discrimination. As weighted scores, the true-response estimates p_{iq} reflect varying item discrimination in contrast to the observed responses x_{iq} which do not. The combination of a weighted average like the Kelley estimation model of classical test theory with the Rasch model of modern test theory extends the usefulness of the single-parameter logistic model empirically to tests consisting of items that vary substantially in discrimination.

### The Parameter a and Item-Test Correlation

In classical test theory, as noted earlier, the correlation between the response x (0 or 1) to an item and total test score X provides a measure of the discrimination of the item. According to Lord and Novick (1968, p. 378, Equation 16.10.7), in the case of the two-parameter normal-ogive model with θ assumed to have a standard normal distribution (μ_{θ}=0 and σ_{θ}=1), the slope parameter α has the following relationship to a correlation similar to r_{xX}: α=r_{xθ}/\sqrt{1−r_{xθ}²}, where r_{xθ} is a biserial correlation between θ and x equal to either zero or one depending on the value of a latent item-knowledge variable (y) having a standard normal distribution (μ_{y}=0 and σ_{y}=1). The numerator in the formula for this correlation, like the numerator in the corresponding formula for r_{xX}, involves the difference between the mean θ of examinees who get the item right and the mean θ of examinees who get the item wrong (McNemar, 1962, p. 189). Since r_{xθ}/\sqrt{1−r_{xθ}²} is a direct function of r_{xθ}, α in the two-parameter normal-ogive model is a measure of item discrimination in the tradition of classical test theory.

In this tradition, Birnbaum (1968, pp. 402-403) in fact justified the need to measure discrimination in item response models by citing standard deviations of actual item-test correlations (r_{xX}) that were too large to occur by chance. This illustration is of interest here for two reasons: Birnbaum recognized (a) the near-equivalence of X and θ and (b) the role of dichotomous item response measures (x) in the measurement of item discrimination (“. . . item-test biserials approximate item-ability biserials . . . ”). The remainder of this section examines the relationship between item discrimination and the parameter α in Birnbaum's two-parameter logistic model.

Like the normal-ogive model, the two-parameter logistic model must make two assumptions in order to have αᵢ as a slope parameter of (θ_{q}−bᵢ). A straightforward way to expose the two assumptions in this case is to change the scale of θ by multiplying (θ_{q}−bᵢ)+ε_{iq} through by the value of αᵢ (different from a regression coefficient) that will make the standard deviation of the product of αᵢ and ε_{iq} equal to one (S_{α}_{ᵢ}_{ε}_{_{iq}}=1) while assuming, as is traditionally the case, that S_{θ}=1. Just as X=T+E in classical test theory implies that S_{T} =r_{XT}S_{X}, so in modern test theory λ_{iq} =(θ_{q}−bᵢ)+ε_{iq} implies that S_{θ}=r_{λθ}S_{λ}. Since S_{α}_{ᵢ}_{ε}_{_{iq}}=1 and S_{θ}=r_{λθ}S_{λ}=1,

$${α}_{i} {ɛ}_{iq} = \frac{{ɛ}_{iq}}{{S}_{{ɛ}_{{i}_{q}}}} = ( \frac{1}{{S}_{λ} \sqrt{1 - {r}_{λθ}^{2}}} ) {ɛ}_{iq} = ( \frac{{r}_{λθ} {S}_{λ}}{{S}_{λ} \sqrt{1 - {r}_{λθ}^{2}}} ) {ɛ}_{iq} = ( \frac{{r}_{λθ}}{\sqrt{1 - {r}_{λθ}^{2}}} ) {ɛ}_{iq} \qquad ( 34 )$$

which shows that the value of aᵢ corresponds to the value presented by Lord and Novick (1968, p. 378) and by Lord (1980, pp. 31-32) in the normal-ogive case: r_{λθ}/\sqrt{1−r_{λθ}²}, λlike x being a two-valued variable measuring the response to an item. (In fact, r_{λθ}=r_{xθ}.) In Equation (12), the second value (ε_{iq}/S_{ε}_{_{iq}}) is the standardized value of ε_{iq}, whose standard deviation is equal to one. The two assumptions are S_{α}_{ᵢ}_{ε}_{_{iq}}=1 and S_{θ}=1.
Iteration from r_{xX} to r_{xθ}

The near-equivalence of X and θ cited by Birnbaum (1968) suggests the use of iteration to estimate θ_{q} and bᵢ by way of λ_{iq}. The first step in the iteration is to use r_{xX} to estimate λ_{iq}, as described earlier. Subsequent steps use r_{xθ}, the θ values being obtained from the preceding step. Iteration continues till the estimates of both θ and b stabilize. Since r_{xθ}=r_{x(θ-b)}, the result of this procedure corresponds precisely at the item level to Kelley's at the test level, (θ−b) and T both being true scores, as indicated earlier. Since the parameter a is a function of r_{xθ}or r_{λθ} (the two being equal), the use of r_{λθ} to measure item discrimination is tantamount to the use of α to do so in the two-parameter normal-ogive and logistic models. Test analysts who wish to follow the Verhelst and Glas (1995) approach to the accommodation of varying item discrimination in a single-parameter logistic model can also use r_{λθ} in α=r_{xX}/\sqrt{1−r_{xX}²} or r_{xθ} in α=r_{xθ}/\sqrt{1−r_{xθ}²} to help determine the “constant” value of θ in their model. The second of these is the equation used in the following numerical example.

### Numerical Example

This section describes the use of simulated data to compare the single-parameter model in its traditional Rasch form with the form described here, as well as a number of variations of each. The data consisted of individual item responses (0's and 1's) on 10-, 20-, and 30-item tests, each administered to 1,000 examinees. The θ values were randomly selected from a standard normal distribution. The b values for the 10-item test were −1.5, −0.75, 0, 0.75, and 1.5, each repeated once. These ten values were duplicated in the 20-item test and triplicated in the 30-item test. Items created to have each b value were also created to have either of two values of r_{xθ}. One is the maximum possible value for its difficulty, point-biserial correlations having maximum values less than one, and the other is 0.144, chosen to make the mean r_{xθ} for a test equal to 0.400. Table 1 shows these r_{xθ} values in the third-to-last row.

Data creation. Using the θ values and item specifications just described, the following regression equation yielded the probability of a correct response, P_{iq}, for each item and each examinee:

$${P}_{iq} = \sqrt{{\overline{P}}_{i} ( 1 - {\overline{P}}_{i} )} {r}_{ϰθ} {θ}_{q} + {\overline{P}}_{i} ,$$

where P̅ᵢ is the mean over examinees of 1/(1+e^{-(θ}^{_{q}}^{-b}^{ᵢ}⁾). This equation for P_{iq} accommodates both item difficulty (P̅ᵢ) and item discrimination (r_{xθ}) in the determination of the probability of a correct response. Comparison of P_{iq} with R_{iq}, a random number uniformly distributed between 0 and 1, resulted in the simulated response: 1 if R_{iq}≤P_{iq}, 0 otherwise. This procedure determined the response of each examinee to each item on each of the three tests.

Comparison of models. To facilitate comparison with other models, the model described here will be called the delta model because it involves an increment to the single-parameter logistic model to account for item discrimination. In addition to the Rasch model, these other models are the Rasch K model, a single-parameter model described by Verhelst and Glas (1995) that has a “constant” (unfitted) discrimination parameter (a) that may differ in value from item to item, the biserial delta model that uses biserial instead of point-biserial correlations for r_{xθ} in the delta model, and a hybrid model involving Rasch model estimates of b and delta model estimates of θ. The focus of the comparisons will be on the correlations of b and θ estimates with their true values.

Estimation procedures. The estimation procedures differed for the Rasch and the delta models. Estimation for the Rasch and Rasch K models used the maximum-likelihood procedure described by Wright and Panchapakesan (1969), with Newton-Raphson iteration. Involving least squares, estimation for the delta and biserial delta models used Equations (8) and (9) together with the iteration procedure described in the preceding section. Iteration continued till the difference between successive estimates was equal to zero, to two decimal places. The “constant” discrimination parameter a used in the Rasch K model for each item was equal to r_{xθ}/\sqrt{1−r_{xθ}²}, the θ values being the ones estimated separately for each test with the delta model. Both the Rasch and the delta estimation procedures involved joint (b and θ) estimation without any distributional assumptions.

Estimation for the hybrid model used the Rasch procedure for b and, with the b values fixed at their Rasch estimates, the delta procedure for θ.

Results. The five models lined up differently for the estimation of b and the estimation of θ. One tied at the top for b but not for θ, one tied at the top for θ but not for b, and one tied at the top for both. Two did not fare well for either b or θ. The b comparisons involved only the items in the 10-item test, the items in the other tests being specification replicates of these items. The θ comparisons involved all three tests.

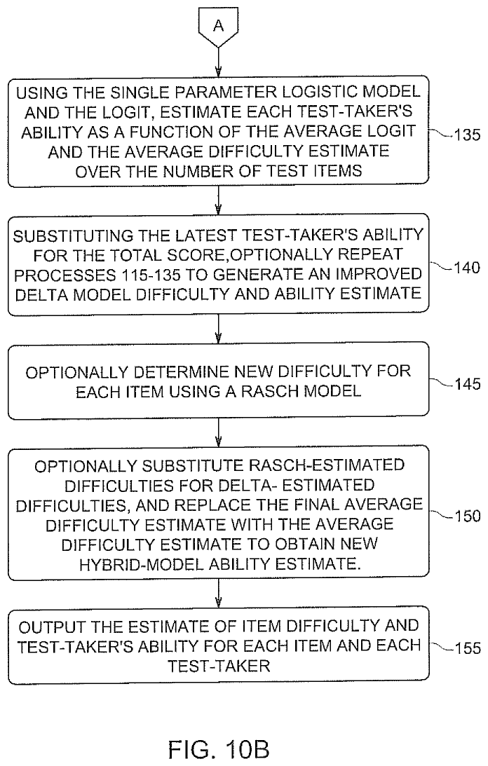

Referring now to the table in FIG. 11, the b results are shown. The top part of the table displays the difficulty and the bottom part the discrimination data for the ten items. The fourth row, labeled “True” in the left column, contains the values of b and the third-from-bottom row contains the values of r_{xθ} used to create the item responses. The remaining rows contain data obtained by parameter estimation. The numerically labeled columns in the top part of the table display the b estimates (b) for the ten items obtained from the use of each of the five models, as well as the mean of these estimates and the correlation, r_{\hat{b}b}, between them and their true values. The r_{\hat{b}b} correlations are substantially lower for the biserial delta, Rasch K, and delta models than for the Rasch and hybrid models, being close to one for the latter two. The mean b estimates are also substantially farther from the true mean for the delta, biserial delta, and Rasch K models than for the Rasch and hybrid models, whose common mean (−0.01) is very nearly equal to the true mean (0.00). The row labeled \hat{α} contains the α estimates for the ten items, along with their mean. The bottom row contains values of the t-Fit statistic described by Wright and Masters (1982, Ch. 5) and Masters (1988). These statistics are interpretable more or less like t statistics, highly negative values expected for items of high discrimination and highly positive values expected for items of low discrimination. The data bore out these expectations, as comparison of the t-Fit values with the α estimates in the second-to-last row and the r_{xθ} values in the third-to-last row shows.

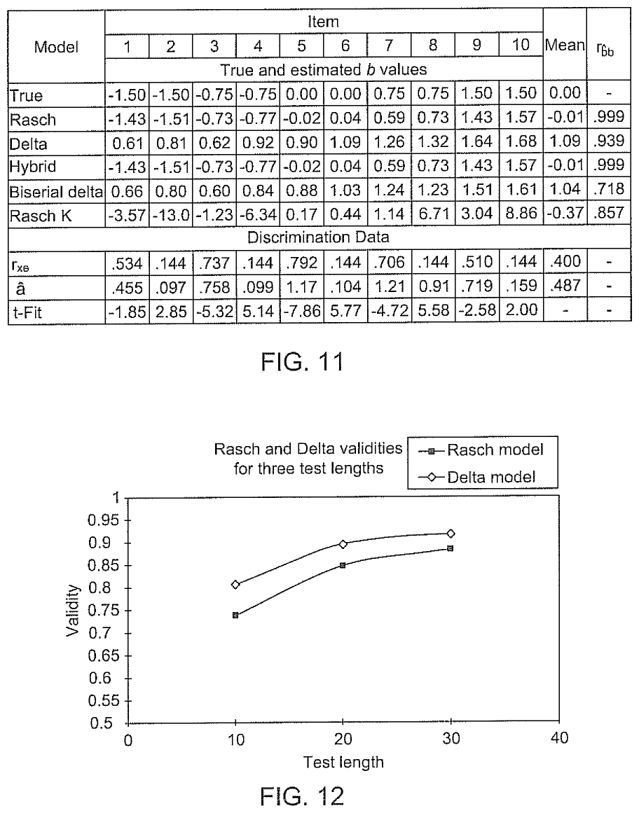

The line-up of the Rasch and delta models was just the opposite for θ estimation, the hybrid model holding the same position in both comparisons. Measuring internal validity, the correlations of the θ estimates with their true values, which increased with test size, were substantially higher in all three tests for the delta and hybrid models (0.807, 0.895, and 0.916) than for the biserial delta model (0.790, 0.860, and 0.895) and the Rasch (0.740, 0.848, and 0.883) and Rasch K (0.679, 0.790, and 0.859) models. Referring now to FIG. 12, results for the delta and hybrid models (top curve) and the Rasch model (bottom curve) are shown. Of particular interest, seen clearly in this figure, is that the delta and hybrid correlation for the 20-item test was higher than the Rasch correlation for the 30-item test.

Discussion. Although the focus here is on the comparison between the Rasch model and the delta model, consideration of the internal-validity standings of the other models is also informative. In yielding unfitted though reasonably differing slopes for the item response curves, the Rasch K model yielded b and θ estimates that had lower internal validities than those of the Rasch model. The biserial delta model sharpened the r_{xθ} differences among the items but, in so doing, distorted both the b and the θ estimates with a consequent degradation in the internal validities of both. In any case, use of either of these models in practice would be expected to produce no better internal validities for either b or θ than their Rasch and delta counterparts.

Because a trade-off exists between test length and item discrimination in their effects on the internal validity of a test (the higher the average item discrimination the lower the test length needed to achieve a specific internal validity), use of a model that weights items directly according to their discrimination measures should produce θ estimates having higher internal validities than use of a model that does not, all else equal. Estimates of θ should, accordingly, have a higher internal validity when produced by the delta model than when produced by the Rasch model from the same test data. That difference is precisely what the results here show for each of the three tests. The difference is in fact so great that, as noted earlier, use of the delta model on the 20-item test produced θ estimates that had a higher internal validity than use of the Rasch model on the 30-item test.

The superiority of the delta over the Rasch model applies only to the estimation of θ. In the estimation of b, the Rasch model is superior to the delta model with respect to both the internal validities and the means of the estimates. This difference is especially important for test developers who maintain item banks and use anchor items in equating tests.

When one model is better for θ and the other for b estimation and when the estimation of both are important, as they both are, which model is a test developer or analyst to use? That question motivated the addition of the hybrid model to the study. The parameter separation that exists in both the Rasch and the delta models suggested that the hybrid model might share the advantages of both. The results confirmed this expectation. Use of the hybrid model in each test resulted in θ estimates that had the internal validity of the delta model and b estimates that had the internal validity, as well as the mean, of the Rasch model. In the line-up of all five models, the hybrid model was clearly the best in both θ and b estimation.

To study the effect of differences in item discrimination on parameter estimation, the data were created in an attempt to maximize these differences while maintaining a reasonable mean value. The t-Fit statistics, shown in the bottom row of the table in FIG. 11, indicate that this attempt was successful. Although the dispersion of item discrimination measures in actual data is not likely to be so large as in the data studied here, some dispersion will always occur in practice. The differential effects found in this simulation study may correspondingly be smaller in the real world, but they will nevertheless exist there. While retaining the Rasch model's advantages in the estimation of item difficulties, use of the hybrid model will make the existence of real-world differences in item discrimination less of a challenge than it would be with use of the Rasch model.

Test developers or analysts reading the description in this specification may wonder why they should fit a single-parameter model to accommodate varying item discrimination when the option exists simply to use the two-parameter logistic or normal-ogive model for the same purpose. One important reason may be this: Single-parameter models do not permit the crossing of item response curves that two-parameter models do. Another reason, at least as important: Like the delta model, two-parameter models may distort the distribution of b estimates in the process of increasing the precision of θ estimation. The first is a theoretical, the second a practical problem. The hybrid model avoids both.

Embodiments of the present technology can be used in various applications of single-parameter logistic models, which yield the probability of an outcome as a function of the ability of the performer and the difficulty of the job whenever the purpose of these applications is to obtain estimates of performer ability and job difficulty. Use of embodiments of the present technology will result in improved estimation of performer ability and, combined with the Rasch model, improved estimation of job difficulty, as well. Examples of other applications include baseball, involving a player's ability to hit and the difficulty of hitting a pitcher, and spelling bees, involving the spelling ability of a contestant and the difficulty of a word to be spelled. It is, however, appreciated that embodiments of the present technology are not limited to these examples.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

We claim:

1. A method comprising:
specifying a desired margin of error for a Bayesian point estimate of an actual population proportion of individuals choosing a particular one of a plurality of options;
determining a sample size needed to achieve the desired margin of error by simulating samples of different sizes, each having a Bayesian point estimate equal to the desired margin of error plus a number equal to one divided by the number of the plurality of options, the determined sample size being the one yielding the desired margin of error;
obtaining from a population of individuals each choosing one of the plurality of options an independent random sample of the size determined to yield the desired margin of error; and
estimating the actual population proportion of individuals choosing the particular one of the plurality of options from a simple Bayesian regression of the estimated population proportion on the computed proportion of individuals in the sample choosing the particular one of the plurality of options using an unbiased classical, non-Bayesian estimator of a square of the correlation between the population proportions and the sample proportions over the plurality of options as the regression coefficient, wherein said sample size is less than a sample size required to achieve said desired margin of error determined without said simulating and said estimating.

2. The method according to claim 1, wherein the square of the correlation between the population proportions and sample proportions over the plurality of options is a function of (a) a sum of squares of the sample proportions over the plurality of options computed from the sample of the determined size, (b) the number of the plurality of options, and (c) the determined sample size.

3. The method according to claim 1, further comprising estimating an actual credibility interval as a function of a posterior variance of the population proportion of individuals choosing the particular one of the plurality of options.

4. The method according to claim 3, further comprising estimating the actual credibility interval as a function of a Bayesian point estimate of the actual population proportion and a total of parameters of a Dirichlet distribution, which itself is a function of the determined sample size and the square of the correlation between the population proportions and the sample proportions over the plurality of options.

5. The method according to claim 3, further comprising estimating the actual credibility interval as equal to a Bayesian point estimate of the actual population proportion of individuals choosing the particular one of the plurality of options plus or minus 1.96 times a square root of a posterior variance of the population proportion of individuals choosing the particular one of the plurality of options, that substantially includes 95 percent of possible values of the population proportion, while being smaller than a corresponding confidence interval determined from a conventional estimation of a population proportion.

6. The method according to claim 1, wherein the Bayesian point estimate of a population proportion has a smaller margin of error for any sample size or requires a smaller sample size for any desired margin of error than a conventionally estimated population proportion.

7. The method according to claim 1, wherein a mean of the population proportions and a mean of the sample proportions over the plurality of options are each equal to an inverse of the number of the plurality of options.

8. The method according to claim 1, wherein the square of the correlation between the population proportions and the sample proportions over the plurality of options functions as a shrinkage coefficient.

9. The method according to claim 1, further comprising estimating an actual margin of error for a point estimate calculated from the simple Bayesian regression of the estimated population proportion on the computed sample proportion via a Dirichlet distribution formula if the number of the plurality of options is equal to or greater than two.

10. The method according to claim 1, further comprising estimating an actual margin of error for a point estimate calculated from the simple Bayesian regression of the estimated population proportion on the computed sample proportion via a formula for the standard error of estimate if the number of the plurality of options is equal to two.

11. The method according to claim 5, wherein, uniquely applicable to Bayesian estimation, an actual credibility interval including the Bayesian point estimate of an actual population proportion and containing 95 percent of the possible values of the actual population proportion of individuals choosing the particular one of the plurality of options can have only a single boundary located in the direction from the point estimate toward the mean population proportion at a distance from the point estimate equal to 1.6457 times a square root of a posterior variance of the population proportion of individuals choosing the particular one of the plurality of options.

12. The method according to claim 11, wherein the sample size required for any desired margin of error is even smaller than it is for a credibility interval having two boundaries at a distance on either side of the Bayesian point estimate equal to 1.96 times a square root of a posterior variance of a population proportion and containing 95 percent of the possible values of the population proportion.

13. A method comprising:
specifying a desired margin of error for a Bayesian point estimate of an actual population mean of the measurements of individuals in each of two or more distinctly different groups on a single specified real-number scale on which the mean measurement of the combined groups is equal to zero;
determining an equal sample size for each of the groups needed to achieve the desired margin of error by simulating for one of the groups samples of different sizes, each having a Bayesian point estimate equal to the desired margin of error plus zero, which is the population mean as well as the sample mean of the combined groups, the determined sample size being the one yielding the desired margin of error; and
obtaining from each of the populations of individuals an independent random sample of the size determined to yield the desired margin of error; and estimating the actual population mean of individuals in each group separately from a simple Bayesian regression of the actual population mean for the group on the computed mean of measurements of individuals in the sample obtained from the group using a classical, non-Bayesian estimator of a square of the correlation between the population means and the sample means of the two groups as the regression coefficient, wherein said sample size is less than a sample size required to achieve said desired margin of error.

14. A non-transitory computer-readable medium having instructions stored thereon that, responsive to execution by an electronic system, cause said electronic system to perform operations, the operations comprising:
specifying a desired margin of error for a Bayesian point estimate of an actual population proportion of individuals choosing a particular one of a plurality of options;
determining a sample size needed to achieve the desired margin of error by simulating samples of different sizes, each yielding a Bayesian point estimate equal to the desired margin of error plus a number equal to one divided by the number of the plurality of options, the determined sample size being the one yielding the desired margin of error;
obtaining from a population of individuals each choosing one of the plurality of options an independent random sample of the size determined to yield the desired margin of error; and
estimating the actual population proportion of individuals choosing the particular one of the plurality of options from a simple Bayesian regression of the estimated population proportion on the computed proportion of individuals in the sample choosing the particular one of the plurality of options using an unbiased classical, non-Bayesian estimator of a square of the correlation between the population proportions and the sample proportions over the plurality of options as the regression coefficient, wherein said sample size is less than a sample size required to achieve said desired margin of error determined without said simulating and said estimating.

15. The non-transitory computer readable media of claim 14 wherein the square of the correlation between the population proportions and sample proportions over the plurality of options is a function of (a) a sum of squares of the sample proportions over the plurality of options computed from the sample of the determined size, (b) the number of the plurality of options, and (c) the determined sample size.

16. The non-transitory computer readable media of claim 14 wherein the operations further comprise: estimating an actual credibility interval as a function of a posterior variance of the population proportion of individuals choosing the particular one of the plurality of options.

17. The non-transitory computer readable media of claim 16 wherein the operations further comprise: estimating the actual credibility interval as a function of a Bayesian point estimate of the actual population proportion and a total of parameters of a Dirichlet distribution, which itself is a function of the determined sample size and the square of the correlation between the population proportions and the sample proportions over the plurality of options.

18. The non-transitory computer readable media of claim 16 wherein the operations further comprise: estimating the actual credibility interval as equal to a Bayesian point estimate of the actual population proportion of individuals choosing the particular one of the plurality of options plus or minus 1.96 times a square root of a posterior variance of the population proportion of individuals choosing the particular one of the plurality of options, that substantially includes 95 percent of possible values of the population proportion, while being smaller than a corresponding confidence interval determined from a conventional estimation of a population proportion.

19. The non-transitory computer readable media of claim 14 wherein the Bayesian point estimate of a population proportion has a smaller margin of error for any sample size or requires a smaller sample size for any desired margin of error than a conventionally estimated population proportion.

20. The non-transitory computer readable media of claim 14 wherein a mean of the population proportions and a mean of the sample proportions over the plurality of options are each equal to an inverse of the number of the plurality of options.

21. The non-transitory computer readable media of claim 14 wherein the square of the correlation between the population proportions and the sample proportions over the plurality of options functions as a shrinkage coefficient.

22. A non-transitory computer-readable medium having instructions stored thereon that, responsive to execution by an electronic system, cause said electronic system to perform operations, the operations comprising:
specifying a desired margin of error for a Bayesian point estimate of an actual population mean of the measurements of individuals in each of two or more distinctly different groups on a single specified real-number scale on which the mean measurement of the combined groups is equal to zero;
determining an equal sample size for each of the groups needed to achieve the desired margin of error by simulating for one of the groups samples of different sizes, each having a Bayesian point estimate equal to the desired margin of error plus zero, which is the population mean as well as the sample mean of the combined groups, the determined sample size being the one yielding the desired margin of error;
obtaining from each of the populations of individuals an independent random sample of the size determined to yield the desired margin of error; and
estimating the actual population mean of individuals in each group separately from a simple Bayesian regression of the actual population mean for the group on the computed mean of measurements of individuals in the sample obtained from the group using a classical, non-Bayesian estimator of a square of the correlation between the population means and the sample means of the two groups as the regression coefficient, wherein said sample size is less than a sample size required to achieve said desired margin of error.
